(19) United States
(12) Patent Application Publication
(10) Pub. No.: US 2009/0249807 A1
(43) Pub. Date: Oct. 8, 2009

(54) HVAC and Battery Thermal Management for a Vehicle

(75) Inventors: Mark D. Nemesh, Troy, MI (US); Edwin J. Stanke, Pontiac, MI (US); Matthew J. Martinchick, Farmington, MI (US); Wissam Ibri, Sterling Heights, MI (US); Kul Winder Singh, Lake Orion, MI (US)

Correspondence Address: GENERAL MOTORS COMPANY;LEGAL STAFF, MAIL CODE 482-C23-B21, P O BOX 300, DETROIT, MI, 48265-3000, US

(73) Assignee: GM GLOBAL TECHNOLOGY OPERATIONS, INC., Detroit, MI (US)

(21) Appl. No.: 12/062,770

(22) Filed: Apr. 4, 2008

(51) Int. Cl. F25D 23/12; B60H 1/32

(52) U.S. Cl. 62/117; 62/259.2; 62/498

(57) ABSTRACT

A HVAC and battery thermal system and method for a vehicle having a passenger cabin and a battery pack is disclosed. The system may comprise a refrigerant loop and a coolant loop. The refrigerant loop includes a first leg and a second leg, the first leg including an expansion device and an evaporator, and the second leg including an expansion device and a chiller. The coolant loop directs coolant through the battery pack and includes a controllable coolant routing valve, a bypass branch and a chiller branch, with the chiller in the chiller branch. The coolant routing valve has a bypass outlet that directs the coolant into the bypass branch and a chiller outlet that directs the coolant into the chiller branch. The coolant loop may also include a radiator branch and battery radiator, with the coolant routing valve including a radiator outlet that directs the coolant into the radiator branch.

### BACKGROUND OF INVENTION

The present invention relates generally to heating, ventilation and air conditioning (HVAC) systems and thermal systems for battery packs in vehicles.

Advanced automotive vehicles are being introduced that employ a battery pack to store large amounts of energy for electric propulsion systems. These vehicles may include, for example, plug-in hybrid electric vehicles, electric vehicles with an internal combustion engine that is used as a generator for battery charging, and fuel cell vehicles. In general, these battery packs require some type of thermal system for cooling and warming the battery pack.

Typical battery thermal systems used to cool and warm the battery pack rely on air flow from the vehicle HVAC system. This may be passenger cabin air that is directed through the battery pack. But these systems suffer from drawbacks such as low heat rejection due to the low heat transfer coefficient of air, interior passenger cabin noise, vibration and harshness (NVH) due to battery blower motor and air rush noise, limited battery cooling capacity after the vehicle has been parked in the sun (due to high air temperatures in the passenger cabin at the beginning of the drive cycle), and difficulty in ensuring that an air inlet grille between the passenger cabin and the battery thermal system does not get accidentally blocked by vehicle passengers (resulting in reduced or no battery air cooling flow).

### SUMMARY OF INVENTION

An embodiment contemplates a HVAC and battery thermal system for a vehicle having a passenger cabin and a battery pack. The system may comprise a refrigerant loop and a coolant loop. The refrigerant loop may include a compressor, a condenser, a first leg and a second leg, the first leg including an evaporator expansion device and an evaporator configured to provide cooling to the passenger cabin, and the second leg including a battery expansion device and a chiller. The coolant loop is configured to direct a coolant through the battery pack and includes a controllable coolant routing valve, a bypass branch and a chiller branch, with the chiller being located in the chiller branch. The coolant routing valve has a bypass outlet that directs the coolant into the bypass branch and a chiller outlet that directs the coolant into the chiller branch and through the chiller. The coolant loop may also include a radiator branch and battery radiator in the radiator branch, with the coolant routing valve including a radiator outlet that directs the coolant into the radiator branch and through the battery radiator.

An embodiment contemplates a HVAC and battery thermal system for a vehicle having a battery pack. The system may comprise a refrigerant loop and a coolant loop. The refrigerant loop may include a compressor, a condenser, a battery expansion device and a chiller. The coolant loop directs a coolant through the battery pack and includes a controllable coolant routing valve, a bypass branch, a radiator branch, a chiller branch, and a battery radiator in the radiator branch. The chiller is located in the chiller branch. The coolant routing valve has a bypass outlet that directs the coolant into the bypass branch, a chiller outlet that directs the coolant into the chiller branch and through the chiller, and a radiator outlet that directs the coolant into the radiator branch and through the battery radiator.

An embodiment contemplates a method of cooling a passenger cabin and a battery pack of a vehicle, the method comprising the steps of: detecting a cabin cooling load requested for the passenger cabin; detecting a battery thermal load required for the battery pack; if a high passenger cabin cooling load is requested and a relatively equally high level of battery pack cooling load is detected, then a refrigerant compressor is activated to direct a refrigerant through a HVAC module evaporator and a chiller, and a coolant routing valve is set to direct a coolant through the chiller and the battery pack; and if a relatively lower passenger cabin cooling load is requested and a relatively equally low level of battery pack cooling load is detected, then the refrigerant compressor is activated to direct the refrigerant through the HVAC module evaporator and the chiller, and the coolant routing valve is set to direct the coolant through the battery pack and through at least one of the chiller and a chiller bypass line.

An advantage of an embodiment is that the vehicle HVAC system will meet varying passenger cabin air conditioning loads while also being able to meet varying battery cooling and warming loads. The use of a coolant routing valve, chiller and battery radiator allows for added HVAC and battery thermal operating states to meet the varying passenger cabin and battery thermal loads. By maintaining the desired temperature within the battery pack, this may maximize the battery life.

### BRIEF DESCRIPTION OF DRAWINGS

FIG. 1 is a schematic illustration of a vehicle having a HVAC and battery thermal system according to a first embodiment.

FIG. 2 is a table showing operating states used in a method for meeting various thermal needs of the passenger cabin and battery pack.

FIG. 3 is a schematic illustration of a vehicle having a HVAC and battery thermal system according to a second embodiment.

### DETAILED DESCRIPTION

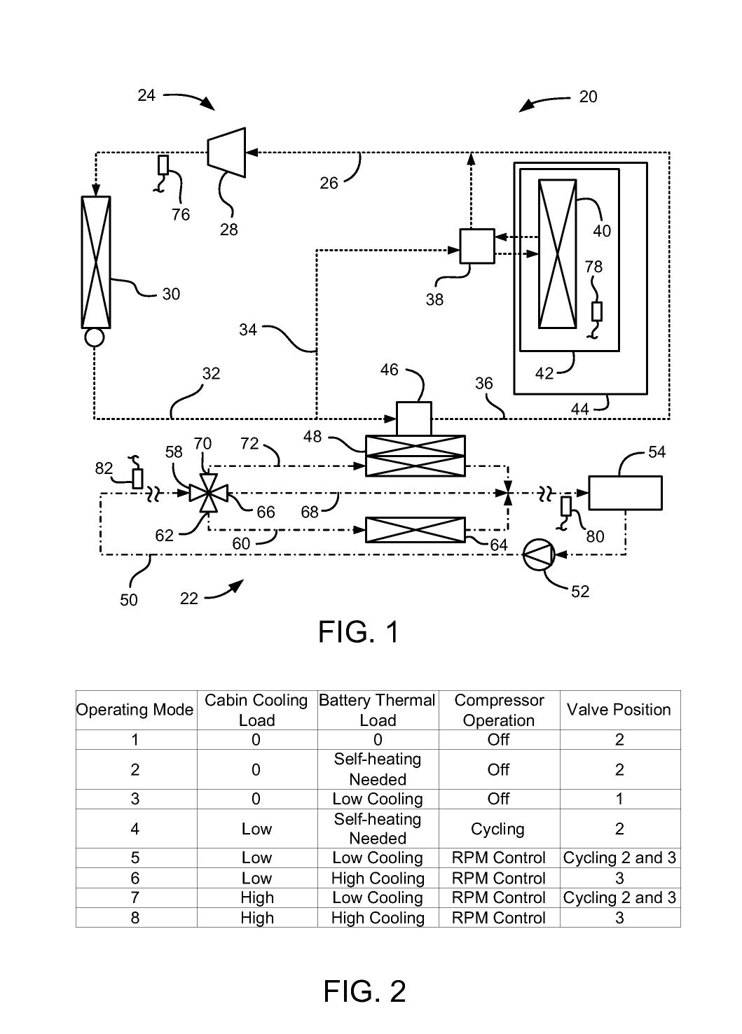

Referring to FIG. 1, a portion of a vehicle, indicated generally at 20, includes a vehicle HVAC and battery thermal system 22. The system 22 includes an air conditioning portion 24 having a refrigerant loop 26. The refrigerant loop 26 includes a refrigerant compressor 28 and a condenser 30. The refrigerant compressor 28 may be electrically driven, with an ability to adjust the speed (RPMs) of the compressor during operation. The condenser 30, in turn, directs refrigerant into a refrigerant line 32 that forks into a first leg 34 and a second leg 36 of the refrigerant loop 26.

The first leg 34 directs refrigerant through an evaporator thermal expansion valve 38 (or other expansion device) into an evaporator 40, which is located in a heating, ventilation and air conditioning (HVAC) module 42 in a passenger cabin 44 of the vehicle 20. Refrigerant exiting the evaporator 40 is directed through a return portion of the evaporator thermal expansion valve 38 and back to the compressor 28 to complete the first leg 34 of the refrigerant loop 26.

The second leg 36 directs refrigerant through a battery thermal expansion valve 46 (or other expansion device). The battery thermal expansion valve 46 is, in turn, in fluid communication with a battery refrigerant-to-coolant heat exchanger (chiller) 48. Refrigerant exiting the chiller 48 is directed through a return portion of the battery thermal expansion valve 46 and back to the compressor 28 to complete the second leg 36 of the refrigerant loop 26.

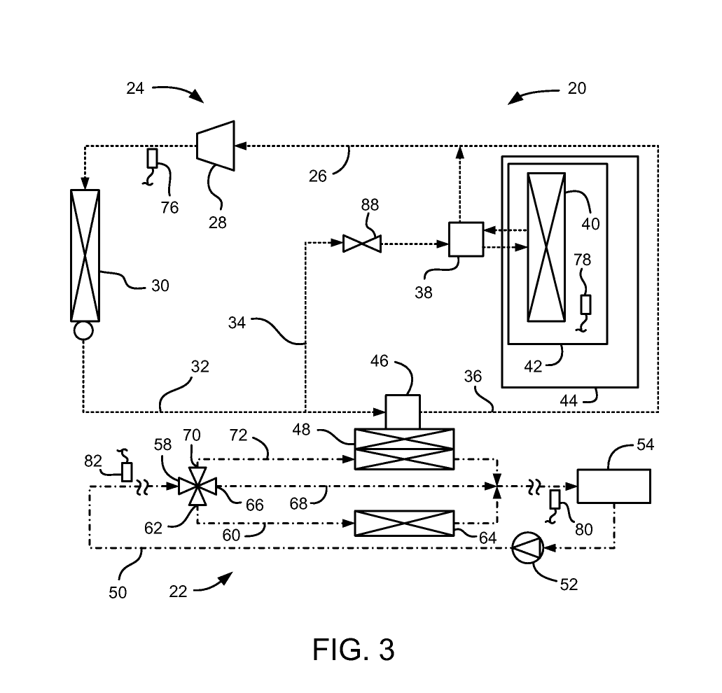

The chiller 48 is also in fluid communication with a coolant loop 50. The dashed lines in FIGS. 1 and 3 represent conduits through which refrigerant flows, while the dash-dot lines represent conduits through which a coolant liquid flows. The coolant may be a conventional liquid mixture such as an ethylene glycol and water mix, or may be some other type of liquid with suitable heat transfer characteristics.

The coolant loop 50 may also include a coolant pump 52 for pumping the coolant through the loop 50. The coolant loop 50 flows through a battery pack 54, where the coolant is employed to cool the battery pack 54. A coolant routing valve 58 is located in the coolant loop 50 and can be selectively actuated to redirect the coolant through three different branches of the coolant loop 50. A first outlet 62 of the valve 58 directs coolant to a first branch 60, which includes a battery radiator 64. The battery radiator 64 may be positioned to have air flowing through it to absorb heat from the coolant. A second outlet 66 of the valve 58 directs coolant to a second branch 68, which forms a coolant bypass line. A third outlet 70 of the valve 58 directs coolant to a third branch 72, which includes the chiller 48. The three branches 60, 68, 72 come together upstream of the battery pack 54 to direct the coolant into the battery pack 54.

The HVAC system 22 may also include various sensors for detecting a temperature or pressure at certain points in the system. For example, the HVAC system 22 may include a high side pressure sensor 76 for measuring the refrigerant pressure just after the refrigerant exits the compressor 28. An evaporator air temperature sensor 78 may be employed to measure the temperature of air flowing out of the evaporator 40. Also, a first coolant temperature sensor 80 may be employed to measure the temperature of coolant upstream of the battery pack 54 and a second coolant temperature sensor 82 may be employed to measure the temperature of coolant just prior to entering the coolant routing valve 58.

FIG. 2 illustrates a table showing operating states used in a method for meeting various thermal needs of the passenger cabin 44 and battery pack 54 illustrated in FIG. 1. The need for battery cooling and heating may be dependent upon ambient conditions, current electric power usage as well as the current battery temperature, which can be different than the current passenger cabin cooling (or heating) load.

For operating mode 1, the passenger cabin air conditioning is off (cabin cooling load 0) and battery cooling or heating is not currently needed (battery thermal load 0). In this operating mode, then, the compressor 28 is off, so no refrigerant will flow, and the coolant routing valve is set to direct coolant through the second output 66 (valve position 2) to the coolant bypass line 68.

For operating mode 2, the passenger cabin air conditioning is off and battery warming (self-heating) is desired. As with the first operating mode, the compressor 28 is off, and the coolant routing valve 58 is set to the second outlet 66 (valve position 2). A battery internal heater (not show) or other suitable heater, such as a coolant heater (not shown) in the coolant loop 50 may be employed to provide the battery warming.

For operating mode 3, the passenger cabin air conditioning is off and the vehicle 20 may be, for example, in electric operating mode, with a low battery cooling load. In this mode, the compressor 28, then, is off, and the coolant routing valve 58 is set to the first outlet 62 (valve position 1). This directs the coolant through the battery radiator 64 in the first branch 60 of the coolant loop 50. The air flowing through the battery radiator 64 will remove some heat from the coolant, thus providing some cooling to the battery pack 54. While the battery radiator 64 does not provide as much cooling to the coolant as the chiller 48, energy is saved by not operating the compressor 28.

For operating mode 4, the HVAC module 42 for the passenger cabin 44 may be in, for example, a dehumidification mode (thus having a low cabin cooling load), with battery warming currently needed. In this mode, the compressor 28 is cycled on and off as needed to meet the cooling load for the evaporator 40, and the coolant routing valve 58 is set to the second outlet 66 (valve position 2) to bypass the chiller 48 and battery radiator 64 via the bypass line 68. Thus, the cold refrigerant passing through the chiller 48 will not cool the coolant. The battery heater (not show) may be employed to provide the battery warming.

For operating mode 5, the passenger cabin 44 has a low cooling load and the battery pack 54 has a low cooling load. In this mode, the compressor 28 is on, with the speed (RPMs) controlled to account for the low loads. The evaporator air temperature sensor 78 may be one of the inputs used to determine the desired compressor speed. The coolant routing valve 58 may be set to the second outlet 66, the third outlet 70 (valve position 3), or cycled between the second and third outlets 66, 70 depending upon the current amount of battery cooling needed and the coolant temperature. The first and second coolant temperature sensors 80, 82 (as well as battery temperature and operating state) may be used as inputs in determining the desired position of the coolant routing valve 58 in this mode. Alternatively, the chiller capacity can be controlled setting the coolant routing valve 58 to allow for a portion of the coolant to be directed through the chiller 48 and the other portion of the coolant to be directed through the bypass 68, rather than cycling the valve 58 back and forth between flow through the chiller 48 and flow through the bypass 68. This alternative, of course, would require the use of a valve that can allow for proportioned flow control.

For operating mode 6, the passenger cabin air conditioning is on low, and the vehicle 20 may be operating in electric vehicle mode with a high battery cooling need (such as electric vehicle mode operation while driving up long steep grade roads). In this mode, the compressor 28 is on, with the speed (RPMs) controlled to meet the refrigerant cooling needs. The coolant routing valve 58 is set to the third outlet 70 in order to direct all of the coolant through the chiller 48 to maximize the cooling effect on the coolant.

For operating mode 7, the passenger cabin air conditioning is on high, while the battery pack 54 only needs a small amount of cooling. This may occur, for example, during initial cool down of a heat soaked passenger cabin 44 while only mild electrical loads are placed on the battery pack 54. In this mode, the compressor 28 is on, with its speed (RPMs) controlled to meet the cooling needs of the evaporator 40. Since the cooling needs for the passenger cabin 44 are much higher than the battery pack 54, the coolant routing valve 58 may be set to the second outlet 66, the third outlet 70, or cycled between the second and third outlets 66, 70 depending upon the current amount of battery cooling needed and the coolant temperature.

For operating mode 8, both the passenger cabin 44 and battery pack cooling loads are high. This may occur, for example, during initial cool down of a heat soaked passenger cabin 44 while the vehicle 20 may be operating in electric vehicle mode with a high battery cooling need (such as electric vehicle mode operation while driving up long steep grade roads). In this mode, the compressor 28 is on, with its speed (RPMs) controlled to meet the cooling needs of the evaporator 40. The coolant routing valve 58 is set to the third outlet 70 in order to direct all of the coolant through the chiller 48 to maximize the cooling effect on the coolant.

FIG. 3 illustrates a second embodiment. Since this embodiment is similar to the first, similar element numbers will be used for similar elements, and the detailed description thereof will be omitted. In this embodiment, an evaporator refrigerant shut-off valve 88 is added to the first leg 34 just upstream of the evaporator thermal expansion valve 38. This allows the refrigerant flow to the evaporator 40 to be stopped, while still allowing for refrigerant flow through the chiller 48. Alternatively, one may employ an electronic thermal expansion valve instead of the evaporator thermal expansion valve 38 and the shut-off valve 88, which would still allow stopping the flow of refrigerant to the evaporator 40.

With this embodiment of the HVAC and battery thermal system 22, another operating mode may be achieved. Such a mode may occur when the passenger cabin air conditioning is off, with the vehicle 20 operating in electric vehicle mode with a high battery cooling need (such as electric vehicle mode operation while driving up long steep grade roads). In this mode, the compressor 28 is on and the shut-off valve 88 is closed, thus allowing for refrigerant flow through the chiller 48 while blocking refrigerant flow through the evaporator 40. The coolant routing valve 58 is set to the third outlet 70 in order to direct all of the coolant through the chiller 48 to maximize the cooling effect on the coolant. Speed (RPM) control of the compressor 28 may be employed to match the cooling capabilities with the battery thermal load.

While certain embodiments of the present invention have been described in detail, those familiar with the art to which this invention relates will recognize various alternative designs and embodiments for practicing the invention as defined by the following claims.

What is claimed is:

1. A HVAC and battery thermal system for a vehicle having a passenger cabin and a battery pack, the system comprising:
a refrigerant loop including a compressor, a condenser, a first leg and a second leg, the first leg including an evaporator expansion device and an evaporator configured to provide cooling to the passenger cabin, and the second leg including a battery expansion device and a chiller; and
a coolant loop configured to direct a coolant through the battery pack and including a controllable coolant routing valve, a bypass branch and a chiller branch, the chiller being located in the chiller branch, and the coolant routing valve having a bypass outlet that directs the coolant into the bypass branch and a chiller outlet that directs the coolant into the chiller branch and through the chiller.

2. The system of claim 1 wherein the coolant loop includes a radiator branch and battery radiator in the radiator branch, and the coolant routing valve includes a radiator outlet that directs the coolant into the radiator branch and through the battery radiator.

3. The system of claim 1 wherein the first leg includes a refrigerant shut-off valve configured to selectively block a flow of a refrigerant through the first leg.

4. The system of claim 1 wherein the evaporator expansion device is an electronic thermal expansion valve configured to selectively block a flow of a refrigerant therethrough.

5. The system of claim 1 including a first coolant temperature sensor configured to measure a coolant temperature just upstream of the battery pack and a second coolant temperature sensor configured to measure the coolant temperature just upstream of the coolant routing valve.

6. The system of claim 1 wherein the coolant loop includes a coolant pump configured to selectively pump the coolant through the coolant loop.

7. The system of claim 1 wherein the battery expansion device is a thermal expansion valve.

8. The system of claim 1 wherein the compressor is an electrically driven compressor that is speed controllable.

9. A HVAC and battery thermal system for a vehicle having a battery pack, the system comprising:
a refrigerant loop including a compressor, a condenser, a battery expansion device and a chiller; and
a coolant loop configured to direct a coolant through the battery pack and including a controllable coolant routing valve, a bypass branch, a radiator branch, a chiller branch, and a battery radiator in the radiator branch, the chiller being located in the chiller branch, and the coolant routing valve having a bypass outlet that directs the coolant into the bypass branch, a chiller outlet that directs the coolant into the chiller branch and through the chiller, and a radiator outlet that directs the coolant into the radiator branch and through the battery radiator.

10. The system of claim 9 including a first coolant temperature sensor configured to measure a coolant temperature just upstream of the battery pack and a second coolant temperature sensor configured to measure the coolant temperature just upstream of the coolant routing valve.

11. The system of claim 9 wherein the coolant loop includes a coolant pump configured to selectively pump the coolant through the coolant loop.

12. The system of claim 9 wherein the battery expansion device is a thermal expansion valve.

13. The system of claim 9 wherein the compressor is an electrically driven compressor that is speed controllable.

14. A method of cooling a passenger cabin and a battery pack of a vehicle, the method comprising the steps of:
(a) detecting a cabin cooling load requested for the passenger cabin;
(b) detecting a battery thermal load required for the battery pack;
(c) if a high cabin cooling load is requested and a relatively equally high level of battery pack cooling load is detected, then a refrigerant compressor is activated to direct a refrigerant through a HVAC module evaporator and a chiller, and a coolant routing valve is set to direct a coolant through the chiller and the battery pack; and
(d) if a relatively lower cabin cooling load is requested and a relatively equally low level of battery pack cooling load is detected, then the refrigerant compressor is activated to direct the refrigerant through the HVAC module evaporator and the chiller, and the coolant routing valve is set to direct the coolant through the battery pack and through at least one of the chiller and a chiller bypass line.

15. The method of claim 14 including (e) if no cabin cooling load is requested and a relatively lower battery pack cooling load is detected, then the coolant routing valve is set to direct the coolant through the battery pack and through a battery radiator.

16. The method of claim 14 wherein step (c) is further defined by a speed of the refrigerant compressor being controlled to meet the required battery pack cooling load and the requested cabin cooling load.

17. The method of claim 14 including (e) if a relatively lower cabin cooling load is requested and a relatively higher battery pack cooling load is detected, then the refrigerant compressor is activated to direct the refrigerant through the HVAC module evaporator and the chiller, and the coolant routing valve is set to direct the coolant through the battery pack and through the chiller.

18. The method of claim 14 wherein step (d) is further defined by cycling the coolant routing valve between directing the coolant through the chiller and routing the coolant through the chiller bypass line.

19. The method of claim 14 including (e) if a battery heating load is detected for the battery pack, then setting the coolant routing valve to direct the coolant through the chiller bypass line.

20. The method of claim 14 including (e) if a relatively higher cabin cooling load is requested and a relatively lower battery pack cooling load is detected, then the refrigerant compressor is activated to direct the refrigerant through the HVAC module evaporator and the chiller, and the coolant routing valve is set to direct the coolant through the battery pack and a first portion of the coolant through the chiller and a remaining portion of the coolant through the chiller bypass line.
